(19) United States
(12) Patent Application Publication
(10) Pub. No.: US 2025/0249904 A1
(43) Pub. Date: Aug. 7, 2025

(54) METHOD AND APPARATUS FOR RECOMMENDING A PICK UP LOCATION FOR A SELF-DRIVING VEHICLE

(71) Applicants: HYUNDAI MOTOR COMPANY, Seoul (KR); KIA CORPORATION, Seoul (KR)

(72) Inventor: Jun Soo Kim, Seoul (KR)

(73) Assignees: HYUNDAI MOTOR COMPANY, Seoul (KR); KIA CORPORATION, Seoul (KR)

(21) Appl. No.: 18/970,446

(22) Filed: Dec. 5, 2024

(30) Foreign Application Priority Data
Feb. 2, 2024 (KR) 10-2024-0016884

(51) Int. Cl. B60W 30/18; G01C 21/34

(52) U.S. Cl. CPC B60W 30/18009; G01C 21/3407

(57) ABSTRACT

A method and apparatus for recommending a pick-up location to a vehicle having an autonomous parking function. The method includes: obtaining user-related information including a desired boarding time of a user, a desired pick-up location of the user, and an estimated parking time of the vehicle; obtaining location-related information including traffic conditions around a location of the vehicle; determining a pick-up location of the user based on the user-related information and the location-related information; recommending the pick-up location to the vehicle; and setting the pick-up location selected by the user as a destination of the vehicle.

### CROSS-REFERENCE TO RELATED APPLICATION

This application claims priority to Korean Patent Application No. 10-2024-0016884, filed on Feb. 2, 2024, the entire contents of which are incorporated herein by reference.

### TECHNICAL FIELD

The present disclosure relates to a method and apparatus for recommending a pick-up location to a vehicle having an autonomous parking function.

### BACKGROUND

The content described below simply provides background information related to the present embodiment and does not constitute prior art.

Automatic parking is a parking method for moving an autonomous vehicle from a road to a parking space without human intervention. Since a vehicle is not fixed to a parking spot and can move, the vehicle can move to a specific location after a user alights.

However, such an automatic parking service does not provide a function of suggesting an appropriate pick-up location to a vehicle, and thus there are cases in which the vehicle does not arrive at a pick-up location designated by a user within a time designated by the user.

In addition, there is a problem that it is difficult to determine a parking location of the vehicle because the user needs to manually search for information on the surroundings to determine a parking location and cannot check whether there is a free parking space.

In addition, even if the user wishes to use a specific service, the service is used after the user has boarded the vehicle, and thus time cannot be used efficiently and there is a problem of wasted time between parking of the vehicle and boarding of the user.

### SUMMARY

An object of the present disclosure is to provide a method and apparatus for recommending a pick-up location to a vehicle having an automatic parking function by ascertaining traffic conditions and/or a list of services that can be provided.

According to an embodiment of the present disclosure, an object is to provide a method and apparatus for recommending a parking location to a vehicle having the automatic parking function.

According to an embodiment of the present disclosure, an object is to provide a method and apparatus for providing a list of available services to a vehicle having the automatic parking function.

The objects to be achieved by the present disclosure are not limited to the objects mentioned above, and other objects that are not mentioned should be clearly understood by those having ordinary skill in the art from the description below.

According to at least an aspect, the present disclosure provides a method for recommending a pick-up location to a vehicle having an automatic parking function. The method comprises: obtaining user-related information including a desired boarding time of a user, a desired pick-up location of the user, and an estimated parking time of the vehicle; obtaining location-related information including traffic conditions around a location of the vehicle; determining a pick-up location of the user in consideration of the user-related information and the location-related information; recommending the pick-up location to the vehicle; and a process of setting the pick-up location selected by the user as a destination of the vehicle.

According to another aspect of the present disclosure, an apparatus comprises: at least one memory configured to store instructions; and at least one processor configured to execute the instructions. In particular, the at least one processor is configured to, by executing the instructions: obtain user-related information including a desired boarding time of a user, a desired pick-up location of the user, and an estimated parking time of a vehicle; obtain location-related information including traffic conditions around a location of the vehicle; determine a pick-up location of the user in consideration of the user-related information and the location-related information; recommend the pick-up location to the vehicle; and set the pick-up location selected by the user as a destination of the vehicle.

According to an embodiment of the present disclosure, it is possible to recommend a pick-up location to a vehicle having the automatic parking function by reflecting surrounding traffic conditions. By changing the recommended location to a pick-up location, it is possible to save the time required to board the vehicle.

According to an embodiment of the present disclosure, it is possible to recommend a parking lot by reflecting services that can be provided to a vehicle around the location of the vehicle. User convenience can be improved because a user can find a parking location without personally searching for information.

According to an embodiment of the present disclosure, it is possible to provide a list of necessary services to a vehicle by reflecting vehicle-related information and allow the vehicle to use the services. User convenience can be improved because the user can use services even if the user does not visit a service provider.

According to an embodiment of the present disclosure, when the user changes a desired pick-up location, a recommended pick-up location can be changed.

The effects that can be obtained from the present disclosure are not limited to the effects mentioned above, and other effects that are not mentioned can be clearly understood by those having ordinary skill in the art from the description below.

### BRIEF DESCRIPTION OF THE DRAWINGS

FIG. 1 is a block diagram schematically showing a system for a pick-up location recommendation service according to an embodiment of the present disclosure.

FIG. 2 is a block diagram schematically showing an apparatus for recommending a pick-up location according to an embodiment of the present disclosure.

FIG. 3 is a flowchart showing a method for providing the pick-up location recommendation service according to an embodiment of the present disclosure.

FIGS. 4A to 4H are exemplary diagrams showing a process of displaying the method for providing a pick-up location recommendation service according to an embodiment of the present disclosure.

FIGS. 5A to 5C are exemplary diagrams showing various examples of screens on which the method for providing a pick-up location recommendation service is displayed according to an embodiment of the present disclosure.

FIG. 6 is a flowchart illustrating a method for recommending a pick-up location according to an embodiment of the present disclosure.

FIG. 7 is a block diagram schematically showing an exemplary computing device that can be used to implement the method or apparatus according to the present disclosure.

### DETAILED DESCRIPTION

Hereinafter, some embodiments of the present disclosure are described in detail with reference to the accompanying drawings. In the following description, like reference numerals preferably designate like elements, although the elements are shown in different drawings. Further, in the following description of some embodiments, a detailed description of known functions and configurations incorporated therein has been omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

When a component, device, element, or the like of the present disclosure is described as having a purpose or performing an operation, function, or the like, the component, device, or element should be considered herein as being “configured to” meet that purpose or to perform that operation or function.

The following detailed description, together with the accompanying drawings, is intended to illustrate embodiments of the present disclosure and is not intended to represent the only embodiments in which the disclosure may be practiced.

In the present disclosure, the vehicle is a means for moving a user to a pick-up location where the user can board. The vehicle may be an autonomous vehicle.

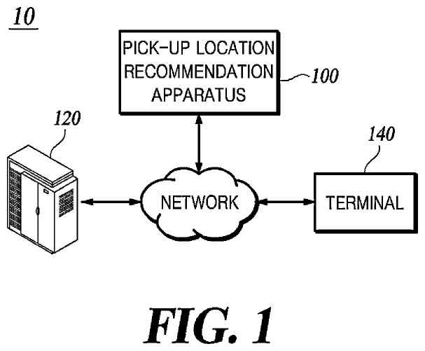

FIG. 1 is a block diagram schematically showing a system for a pick-up location recommendation service according to an embodiment of the present disclosure.

As shown in FIG. 1, the system for the pick-up location recommendation service according to an embodiment of the present disclosure includes a pick-up location recommendation apparatus 100, a server 120, and a terminal 140.

The pick-up location recommendation apparatus 100 is connected to the server 120 and the terminal 140 through a communication network and can exchange data therewith. The pick-up location recommendation apparatus 100 may store and manage information collected from the server 120 and the terminal 140.

The server 120 may be, for example, a server operated by an organization that provides real-time traffic information services or a company that provides operation services of other transportation means, but is not limited thereto.

The terminal 140 may be defined as an electronic device through which a user inputs information necessary to receive a recommended pick-up location. The terminal 140 provides input information to the pick-up location recommendation apparatus 100.

The terminal 140 may be provided as one of various electronic devices such as a smartphone, smartwatch, tablet, computer, ultra mobile PC (UMPC), workstation, net-book, personal digital assistants (PDA), portable computer, and portable multimedia player (PMP). However, the terminal 140 is not limited to the types of devices described above, and any device can serve as the terminal 140 regardless of the specific type as long as it can recommend a pick-up location to the vehicle using a network.

The terminal 140 according to an embodiment of the present disclosure may be equipped with an application for a pick-up location recommendation service. The terminal 140 may request pick-up location recommendation from the pick-up location recommendation apparatus 100 based on the location of a user using the application for the pick-up location recommendation service.

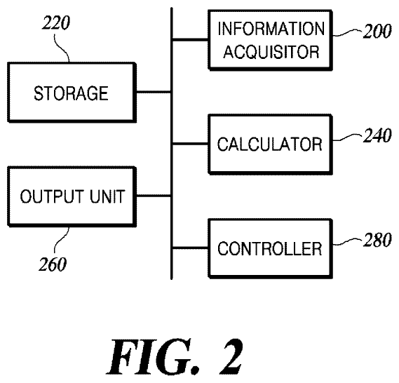

FIG. 2 is a block diagram schematically showing the pick-up location recommendation apparatus 100 according to an embodiment of the present disclosure.

As shown in FIG. 2, the pick-up location recommendation apparatus 100 may include some or all of an information acquisitor 200, a storage 220, a calculator 240, an output unit 260, and a controller 280. Not all blocks shown in FIG. 2 are essential components, and one or more components may be integrated in an actual physical environment.

The information acquisitor 200 may obtain user-related information from the user. The user-related information may include a desired pick-up location of the user, a desired boarding time of the user, a desired service list of the user, a vehicle identifier, an estimated parking time of the vehicle, a vehicle fuel type, vehicle condition, vehicle inspection cycle, and the like. In the case of electric vehicles, the remaining battery capacity may be included. The inspection cycle may include a car wash cycle or a maintenance cycle. The information acquisitor 200 may obtain location-related information from the server. The location-related information may include traffic conditions, parking fees at nearby parking lots, distances to nearby parking lots, travel time to a nearby parking lot, congestion in nearby parking lots, availability of indoor and outdoor parking, a list of available services, and weather conditions.

The storage 220 may store various types of information obtained by the information acquisitor 200 in order to implement the operation of the pick-up location recommendation apparatus 100. For example, to recommend a pick-up location, the storage 220 may store traffic conditions around a desired pick-up location and information on available services provided to the vehicle.

The calculator 240 may recommend a pick-up location by analyzing an estimated parking time, a travel distance from a parking location to a pick-up location, a travel time from the parking location to the pick-up location, the distance from the location of the user to the pick-up location, a user's walking travel time, road traffic conditions, vehicle-related information, and the like. If a desired boarding time of the user is the same as or later than the time when the vehicle arrives at a desired pick-up location, the desired pick-up location is determined as a recommended pick-up location. If the desired boarding time of the user is earlier than the time when the vehicle arrives at the desired pick-up location, a location where the vehicle can arrive at a specific location earlier than the desired boarding time of the user is determined as a recommended pick-up location.

The calculator 240 may recommend a parking lot by analyzing an estimated parking time, boarding time, vehicle-related information, parking fees, distances to nearby parking lots, travel time to a nearby parking lot, congestion in the nearby parking lots, weather conditions, a desired service list, and the like. For example, if a heavy rain watch is issued near a parking location, a parking lot that allows indoor parking can be recommended from a list of nearby parking lots.

The calculator 240 may analyze vehicle-related information such as an estimated parking time, boarding time, vehicle-related information, parking fees, distances to nearby parking lots, travel time to a nearby parking lot, congestion in nearby parking lots, weather conditions, and a desired service list and provide a list of available services. A list of services for which the sum of a vehicle travel time and a time required for a service from a parking location to a service provider is less than the estimated parking time may be used as the list of available services. The list of available services may include a list of services that need to be used. For example, in the case of an electric vehicle, a charging service can be recommended as a service that needs to be used when the remaining battery capacity is below a certain range.

The output unit 260 may be implemented as an interface for transmitting information such as the calculated recommended parking lot information, recommended service list, and recommended pick-up location to the terminal 110 and providing the information to the user, but is not limited thereto.

The controller 280 allows the vehicle to autonomously travel toward a location selected by the user. When the vehicle reaches the destination, the controller 280 stops the vehicle and allows the vehicle to park at the location. When the estimated parking time has elapsed, the vehicle is allowed to travel autonomously toward the pick-up location of the user.

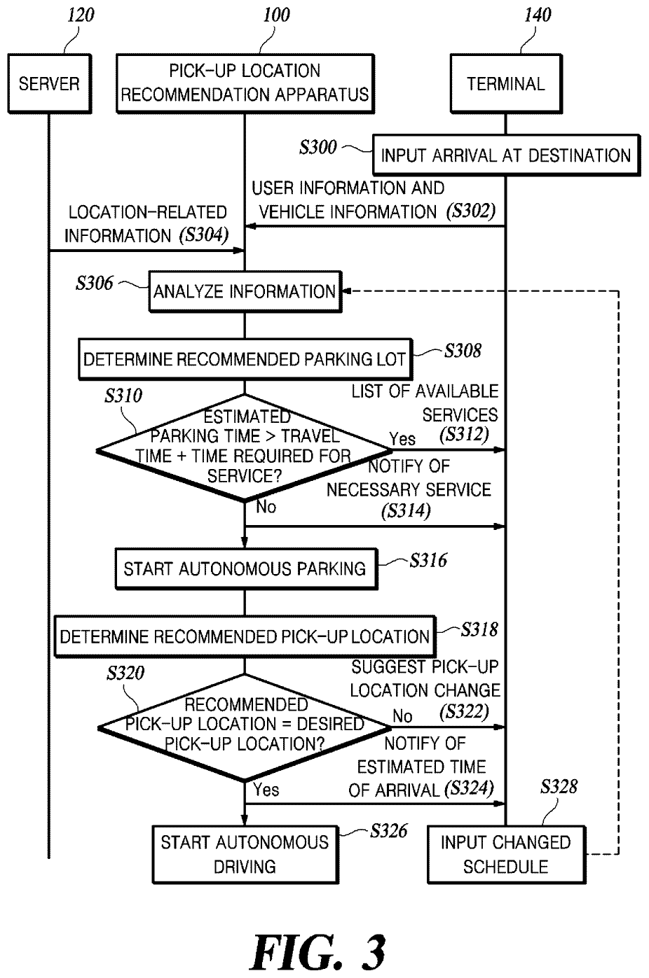

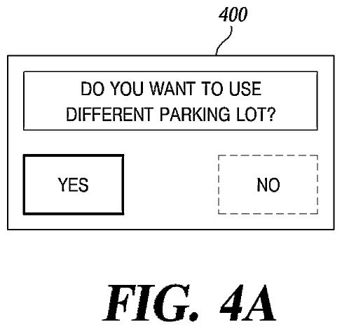

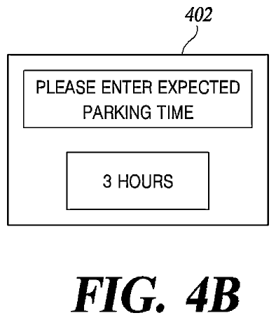

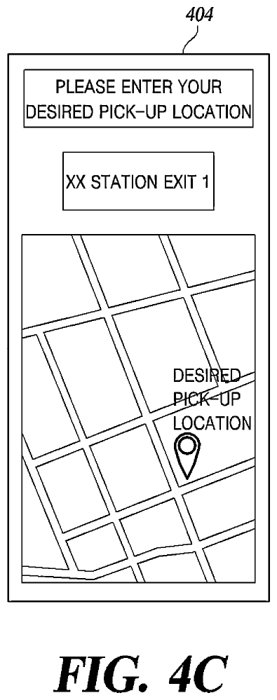

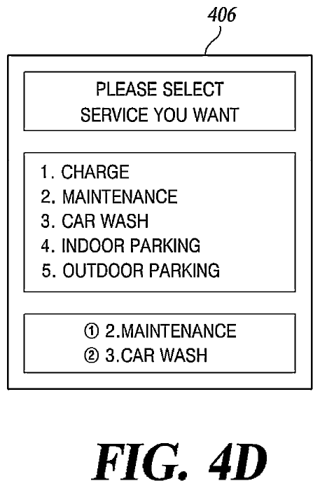

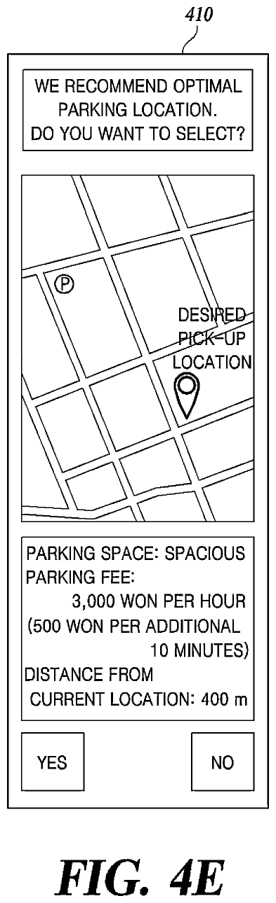

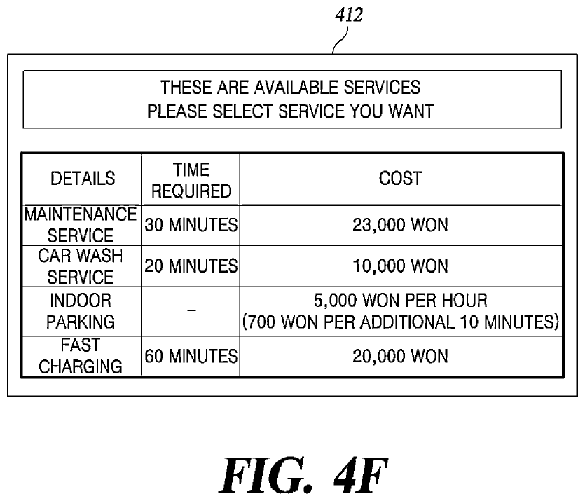

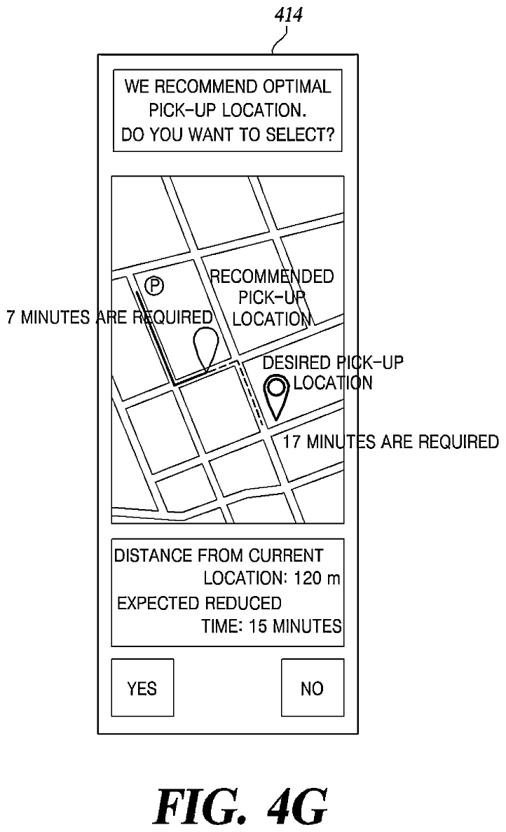

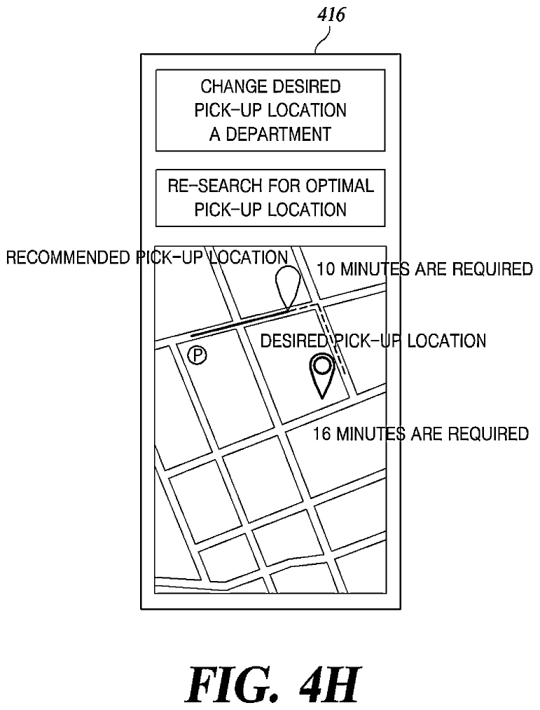

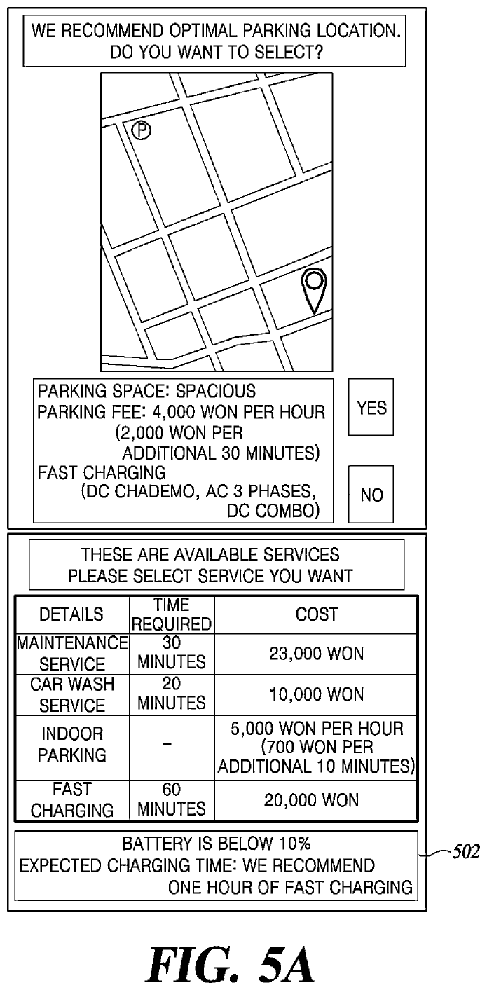

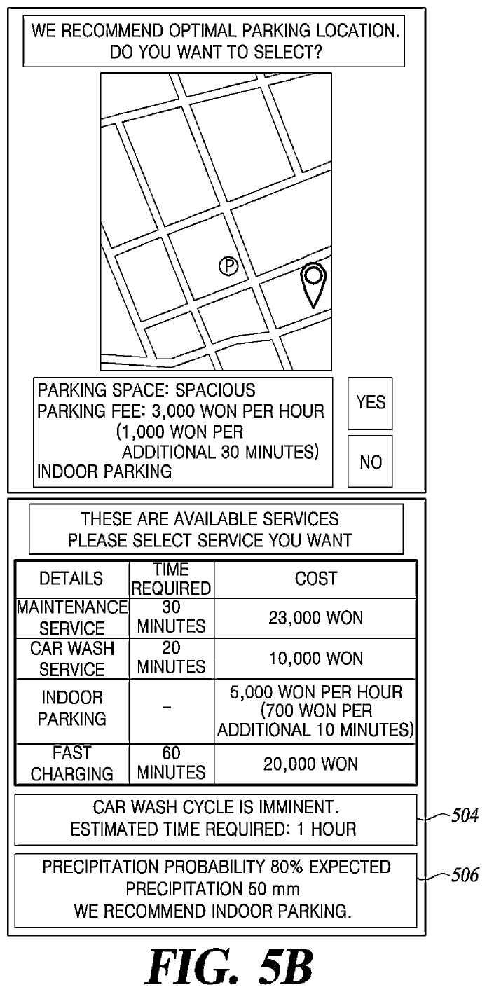

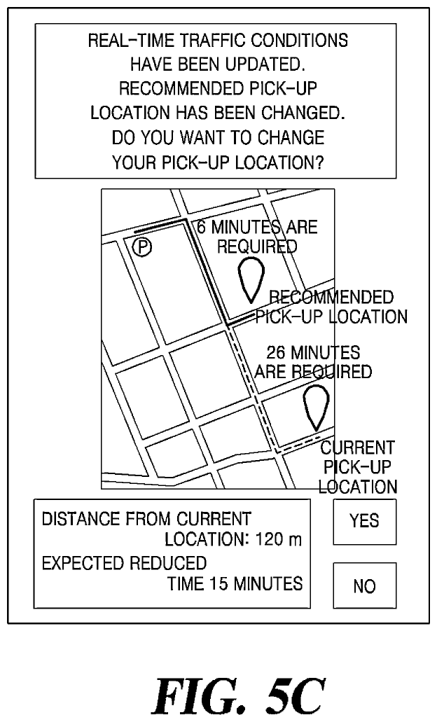

FIG. 3 is a flowchart showing a method for providing a pick-up location recommendation service according to an embodiment of the present disclosure. FIGS. 4A to 4H are exemplary diagrams showing a process of displaying the method for providing the pick-up location recommendation service according to an embodiment of the present disclosure. FIGS. 5A to 5C are exemplary diagrams showing various examples of screens on which the method for providing the pick-up location recommendation service is displayed according to an embodiment of the present disclosure.

Referring to FIG. 4A, after the vehicle arrives at a destination, the pick-up location recommendation apparatus 100 presents an inquiry screen 400 to the user to check whether designated parking is required and requests confirmation of whether the user wants to use another parking lot (in an operation S300).

The terminal 140 transmits user-related information input by the user to the pick-up location recommendation apparatus 100 (in an operation S302). Referring to FIGS. 4B to 4D, the pick-up location recommendation apparatus 100 displays a parking time selection screen 402, a pick-up location selection screen 404, and a desired service selection screen 406 on the terminal 140 and requests user input. The user-related information transmitted from the terminal to the pick-up location recommendation apparatus 100 may include a desired pick-up location of the user, a desired boarding time of the user, a desired service list of the user, a vehicle identifier, an estimated parking time of the vehicle, the fuel type of the vehicle, the condition of the vehicle, the inspection cycle of the vehicle, and the like. In the case of electric vehicles, the remaining battery capacity may be included. The inspection cycle may include a car wash cycle or a maintenance cycle.

The pick-up location recommendation apparatus 100 obtains location-related information from the server (in an operation S304). The location-related information may include parking fees at nearby parking lots, distances to nearby parking lots, travel time to a nearby parking lot, congestion in nearby parking lots, indoor and outdoor parking availability, a list of available services, and weather conditions.

The pick-up location recommendation apparatus 100 analyzes information provided from the server 120 and the terminal 140 (in an operation S306).

The pick-up location recommendation apparatus 100 analyzes an estimated parking time, boarding time, vehicle-related information, parking fees, distances to nearby parking lots, travel time to a nearby parking lot, congestion in nearby parking lots, weather conditions, and a list of desired services to determine a recommended parking lot (in an operation S308). Referring to FIG. 4E, a parking lot recommendation screen 410 may be presented to request confirmation of whether the user wants to use the recommended parking lot. At this time, the pick-up location recommendation apparatus 100 may provide information such as the congestion in the recommended parking lot, the parking fee at the recommended parking lot, the travel distance from the current location, and the time required.

The pick-up location recommendation apparatus 100 compares the sum of the vehicle travel time from the parking location to the service provider and the time required for the service with the estimated parking time to check whether there is a sufficient time for the vehicle to use the service (in an operation S310).

The pick-up location recommendation apparatus 100 provides a list of services available to the vehicle before the desired boarding time of the user to the terminal 140 (in an operation S312). Referring to FIG. 4F, the terminal 140 presents an available service list screen 412 to the user. When the user selects a maintenance service and a car wash service as desired services, information on the selected services is displayed in the upper part, and information on other available services is displayed in the lower part. The pick-up location recommendation apparatus 100 may recommend services that need to be used by analyzing provided information even if the services are not selected by the user. For example, referring to FIG. 5A, when the remaining battery capacity of an electric vehicle is 10% or less, a notification screen 502 may be displayed to notify the user that charging is necessary. As another example, referring to FIG. 5B, when the car wash cycle of the vehicle is imminent, a notification screen 504 may be displayed to notify that user that car washing is necessary. At this time, if it is expected to rain in consideration of the weather forecast, the pick-up location recommendation apparatus 100 may present a recommendation screen 506 to recommend indoor parking.

If the sum of the vehicle travel time from the parking location to the service provider and the time required for the service is greater than the estimated parking time, a list of services that need to be used is notified (in an operation S314). For example, if the car wash cycle is imminent but there is no sufficient time to use the car wash service, the user may be notified that car washing is necessary in the future.

The pick-up location recommendation apparatus 100 allows the vehicle to autonomously travel to the determined parking lot and autonomously park after arriving at the destination (in an operation S316).

The pick-up location recommendation apparatus 100 analyzes the estimated parking time from the parking location, the travel distance from the parking location to the pick-up location, the travel time from the parking location to the pick-up location, road traffic conditions, vehicle-related information, and the like to determine a recommended pick-up location (in an operation S318). Referring to FIG. 5C, even after determining the recommended pick-up location, another pick-up location may be recommended as a recommended pick-up location by reflecting real-time traffic conditions.

The pick-up location recommendation apparatus 100 compares the desired pick-up location with the recommended pick-up location (in an operation S320). Referring to FIG. 4G, if the desired pick-up location is different from the recommended pick-up location, the pick-up location recommendation apparatus 100 provides the travel route and time required from the parking location to the desired pick-up location and suggests pick-up location change (in an operation S322).

If the desired pick-up location is the same as the recommended pick-up location, the pick-up location recommendation apparatus 100 notifies of the time required for the vehicle to arrive at the recommended pick-up location (in an operation S324).

The pick-up location recommendation apparatus 100 sets the recommended pick-up location as a destination of the vehicle and allows the vehicle to start autonomous driving (in an operation S326).

If the user's schedule is changed, the pick-up location recommendation apparatus 100 may reflect the changed information and re-analyze the information to change one or more of the pick-up location, parking location, and available service list (in an operation S328). For example, if the desired pick-up location is changed, the pick-up location recommendation apparatus 100 may change the recommended pick-up location by reflecting the traffic conditions around the changed location. As another example, if the car wash service is added to the desired service list, the pick-up location recommendation apparatus 100 may change the parking location to a location where the car wash service can be used until the estimated boarding time and recommend the location. As another example, if the estimated parking time is reduced, a service for which the sum of the vehicle travel time to the service provider and the time required for the service is less than the estimated parking time may be recommended.

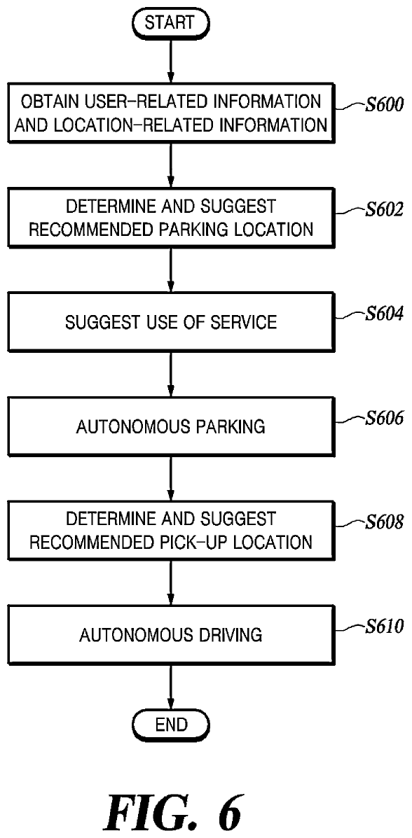

FIG. 6 is a flowchart illustrating a method for recommending a pick-up location according to an embodiment of the present disclosure.

The method shown in FIG. 6 may be performed by the pick-up location recommendation apparatus 100, the server 120, the terminal 140 and the like (hereinafter referred to as a “pick-up location recommendation system”). The pick-up location recommendation system may obtain user-related information and location-related information (in an operation S600). The user-related information may include a desired pick-up location of a user, a desired boarding time of the user, a list of desired services for the user, a vehicle identifier, an estimated parking time of the vehicle, a vehicle fuel type, a vehicle condition, a vehicle inspection cycle, and the like. In the case of electric vehicles, the remaining battery capacity may be included. The inspection cycle may include a car wash cycle or a maintenance cycle. The location-related information may include parking fees at nearby parking lots, distances to nearby parking lots, travel time to a nearby parking lot, congestion in nearby parking lots, indoor and outdoor parking availability, a list of available services, and weather conditions.

The pick-up location recommendation system analyzes an estimated parking time, boarding time, vehicle-related information, parking fees, distances to nearby parking lots, travel time to a nearby parking lot, congestion in nearby parking lots, weather conditions, and a list of desired services to determine a recommended parking locations (in an operation S602).

The pick-up location recommendation system may provide a list of services available to the vehicle before the desired boarding time of the user (in an operation S604). Specifically, the pick-up location recommendation system compares the sum of a vehicle travel time from the parking location to a service provider and a time required for a service with the estimated parking time, and if the vehicle has a sufficient time to use the service, suggests the use of the service. Even if a service is not selected as a desired service by the user, the service may be recommended as a service that needs to be used by analyzing the information provided. If the sum of the vehicle travel time from the parking location to the service provider and the time required for the service is greater than the estimated parking time, a list of required services may be notified.

The pick-up location recommendation system may set the determined parking location as a destination of the vehicle, allow the vehicle to travel autonomously, and allow the vehicle to park autonomously after arriving at the destination (in an operation S606).

The pick-up location recommendation system analyzes the estimated parking time from the parking location, the travel distance from the parking location to the pick-up location, the travel time from the parking location to the pick-up location, road traffic conditions, vehicle-related information, and the like to determine a recommended pick-up location and suggests the recommended pick-up location to the user (in an operation S608). Specifically, if the desired boarding time of the user is identical to or later than the time when the vehicle will arrive at the desired pick-up location, the desired pick-up location is determined as a recommended pick-up location. If the desired boarding time of the user is earlier than the time when the vehicle will arrival at the desired pick-up location, a location where the vehicle can arrive at a specific location earlier than the desired boarding time of the user is determined as a recommended pick-up location. The pick-up location recommendation system compares the desired pick-up location with the recommended pick-up location. If the desired pick-up location is different from the recommended pick-up location, it is possible to suggest pick-up location change by providing the travel route and time required from the parking location to the desired pick-up location. If the desired pick-up location is the same as the recommended pick-up location, it is possible to notify of the time required for the vehicle to arrive at the recommended pick-up location. The pick-up location recommendation system may recommend other pick-up locations (e.g., a new pick-up location) by reflecting real-time traffic conditions even after the recommended pick-up location is determined. When the user's schedule is changed, the pick-up location recommendation system may change the recommended pick-up location by reflecting the changed information.

The pick-up location recommendation system sets the recommended pick-up location as a destination and allows the vehicle to travel autonomously (in an operation S610).

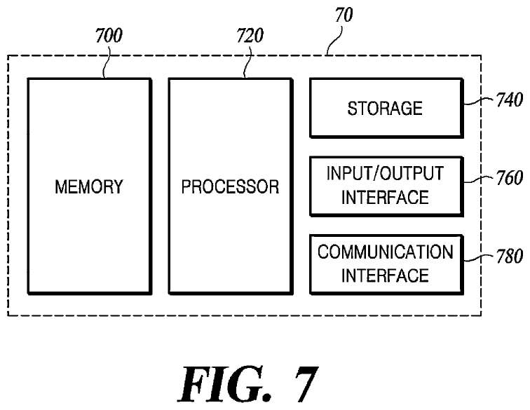

FIG. 7 is a block diagram schematically showing an exemplary computing device that can be used to implement the method or apparatus according to the present disclosure.

The computing device 70 may include some or all of a memory 700, a processor 720, a storage 740, an input/output interface 760, and a communication interface 780. The computing device 70 may structurally and/or functionally include at least a part of the pick-up location recommendation apparatus 100. The computing device 70 may be a stationary computing device such as a desktop computer, a server, and an AI accelerator, and may be f mobile computing device such as a laptop computer and a smartphone.

The memory 700 may store a program that causes the processor 720 to perform method or operations according to various embodiments of the present disclosure. For example, the program may include a plurality of instructions executable by the processor 720, and the method shown in FIG. 6 may be performed by the processor 720 executing the plurality of instructions.

The memory 700 may be a single memory or a plurality of memories. In this case, information required to perform methods or operations according to various embodiments of the present disclosure may be stored in a single memory or stored in a plurality of memories in a distributed manner. When the memory 700 is configured as a plurality of memories, the plurality of memories may be physically separated.

The memory 700 may include at least one of a volatile memory and a non-volatile memory. The volatile memory includes a static random access memory (SRAM) or a dynamic random access memory (DRAM), and the non-volatile memory includes a flash memory.

The processor 720 may include at least one core capable of executing at least one instruction. The processor 720 may execute instructions stored in the memory 700. The processor 720 may be a single processor or a plurality of processors.

The storage 740 maintains stored data even if power supplied to the computing device 70 is cut off. For example, the storage 740 may include a non-volatile memory or may include storage media such as a magnetic tape, an optical disk, and a magnetic disk.

The program stored in the storage 740 may be loaded into the memory 700 before being executed by the processor 720. The storage 740 may store files written in a program language, and a program created from a file by a compiler or the like may be loaded into the memory 700. The storage 740 may store data to be processed by processor 720 and/or data processed by processor 720.

The input/output interface 760 may include an input device such as a keyboard and a mouse, and may include an output device such as a display device and a printer. A user 122 may trigger execution of a program by the processor 720 and/or check processing results of the processor 720 through the input/output interface.

The communication interface 780 may provide access to external networks. For example, the computing device 70 may communicate with other devices through the communication interface 780.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

Although operations are illustrated in the flowcharts/timing charts in this specification as being sequentially performed, this is merely an exemplary description of the technical idea of one embodiment of the present disclosure. In other words, those having ordinary skill in the art to which the present disclosure pertains may appreciate that various modifications and changes can be made without departing from essential features of embodiments of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed present disclosure. Therefore, the embodiments of the present disclosure have been described for the sake of brevity and clarity. The scope of the technical idea of the present disclosure is not limited by the illustrations. Accordingly, one of ordinary skill in the art would understand that the scope of the claimed present disclosure is not to be limited by the above explicitly described embodiments but by the claims and equivalents thereof.

What is claimed is:

1. A method for recommending a pick-up location to a vehicle having an automatic parking function, the method comprising:
obtaining user-related information including a desired boarding time of a user, a desired pick-up location of the user, and an estimated parking time of the vehicle;
obtaining location-related information including traffic conditions around a location of the vehicle;
determining a pick-up location of the user based on the user-related information and the location-related information;
recommending the pick-up location to the vehicle; and
setting the pick-up location selected by the user as a destination of the vehicle.

2. The method of claim 1, wherein determining the pick-up location of the user includes:
determining the desired pick-up location as the pick-up location when the desired boarding time is the same as or later than a time when the vehicle will arrive at the desired pick-up location; and
determining a location at which the vehicle is able to arrive earlier than the desired boarding time as the pick-up location when the desired boarding time is earlier than the time when the vehicle will arrive at the desired pick-up location.

3. The method of claim 1, further comprising: changing the recommended pick-up location to a new pick-up location, wherein changing the recommended pick-up location includes determining the new pick-up location based on the user-related information and the location-related information, which are updated according to a changed schedule of the user.

4. The method of claim 1, wherein recommending the pick-up location comprises providing information including a travel route and a time required from a parking location of the vehicle to the pick-up location to the user.

5. The method of claim 1, further comprising:
determining a parking location of the vehicle based on the user-related information and the location-related information; and
recommending the parking location to the vehicle.

6. The method of claim 5, further comprising: changing the recommended parking location to a new parking location, wherein changing the recommended parking location includes determining the new parking location of the vehicle based on the user-related information and the location-related information, which are updated according to a changed schedule of the user.

7. The method of claim 5, wherein recommending the parking location of the vehicle comprises: providing information including congestion in parking lots, parking fees, a travel distance and a time required from the location of the vehicle to the user.

8. The method of claim 1, further comprising: providing a list of services available during the estimated parking time based on the user-related information and the location-related information.

9. The method of claim 8, further comprising: changing the provided list of available services to a new service list, wherein changing the provided list of available services to the new service list includes providing the new service list available during the estimated parking time based on the user-related information and the location-related information, which are updated according to the changed schedule of the user.

10. The method of claim 8, wherein the list of available services is a list of services for which a sum of a vehicle travel time from a parking location of the vehicle to a service provider and a time required for a service is less than the estimated parking time of the vehicle.

11. The method of claim 8, wherein providing the list of available services comprises providing a list of services that need to be used in consideration of the user-related information and the location-related information.

12. The method of claim 1, further comprising: changing the recommended pick-up location to a new pick-up location through determining the new pick-up location of the user based on the location-related information including real-time traffic conditions.

13. An apparatus comprising:
at least one memory configured to store instructions; and
at least one processor,
wherein the at least one processor is configured to, by executing the instructions:
obtain user-related information including a desired boarding time of a user, a desired pick-up location of the user, and an estimated parking time of a vehicle;
obtain location-related information including traffic conditions around a location of the vehicle;
determine a pick-up location of the user based on the user-related information and the location-related information;
recommend the pick-up location to the vehicle; and
set the pick-up location selected by the user as a destination of the vehicle.

14. The apparatus of claim 13, wherein the at least one processor is configured to:
determine the desired pick-up location as the pick-up location when the desired boarding time is the same as or later than a time when the vehicle will arrive at the desired pick-up location; and
determine a location at which the vehicle is able to arrive earlier than the desired boarding time as the pick-up location when the desired boarding time is earlier than the time when the vehicle will arrive at the desired pick-up location.

15. The apparatus of claim 13, wherein the at least one processor is configured to provide information including a travel route and a time required from a parking location of the vehicle to the pick-up location to the user.

16. The apparatus of claim 13, wherein the at least one processor is configured to:
determine a parking location of the vehicle based on the user-related information and the location-related information; and
recommend the parking location to the vehicle.

17. The apparatus of claim 13, wherein the at least one processor is configured to provide information including congestion in parking lots, parking fees, a travel distance and a time required from a location of a driver to the user.

18. The apparatus of claim 13, wherein the at least one processor is configured to provide a list of services available during the estimated parking time based on the user-related information and the location-related information.

19. The apparatus of claim 18, wherein the list of available services is a list of services for which a sum of a vehicle travel time from a parking location of the vehicle to a service provider and a time required for a service is less than the estimated parking time of the vehicle.

20. A non-transitory computer-readable recording medium storing a computer program, the computer program to direct a processor to perform acts of:
obtaining user-related information including a desired boarding time of a user, a desired pick-up location of the user, and an estimated parking time of a vehicle;
obtaining location-related information including traffic conditions around a location of the vehicle;
determining a pick-up location of the user based on the user-related information and the location-related information;
recommending the pick-up location to the vehicle; and
setting the pick-up location selected by the user as a destination of the vehicle.
